(19) United States
(12) Patent Application Publication
(10) Pub. No.: US 2011/0171518 A1
(43) Pub. Date: Jul. 14, 2011

(54) Three dimensional Battery Architectures and Methods of Making Same

(75) Inventors: Bruce Dunn, Los Angeles, CA (US); Jeffrey W. Long, Alexandria, VA (US); Debra R. Rolison, Arlington, VA (US); Henry S. White, Salt Lake City, UT (US); Fred Wudl, Los Angeles, CA (US); Sarah H. Tolbert, Encino, CA (US); Chang-Jin Kim, Beverly Hills, CA (US)

(73) Assignee: The Government of the United States of America, as represented by the Secretary of the Navy

(21) Appl. No.: 13/052,596

(22) Filed: Mar. 21, 2011

Related U.S. Application Data
(62) Division of application No. 11/464,173, filed on Aug. 11, 2006.
(60) Provisional application No. 60/707,682, filed on Aug. 12, 2005.

(51) Int. Cl. H01M 4/32; H01M 4/38; H01M 2/02; H01M 10/04

(52) U.S. Cl. 429/163; 429/223; 429/229; 29/623.1

(57) ABSTRACT

A three-dimensional electrode structure for use in a battery comprising a porous three-dimensional substrate formed from a first electrically conductive material, an ion-conducting dielectric material disposed on the porous three dimensional substrate, and a second electrically conductive material disposed on the ion-conducting dielectric material, wherein the ion-conducting dielectric material separates the first electrically conductive material from the second electrically conductive material.

### REFERENCE TO RELATED APPLICATIONS

This Application claims priority to U.S. Provisional Patent Application No. 60/707,682 filed on Aug. 12, 2005 and U.S. Non-Provisional patent application Ser. No. 11/464,173 filed on Aug. 11, 2006, both applications are incorporated by reference as if set forth fully herein.

### STATEMENT REGARDING FEDERALLY SPONSORED RESEARCH AND DEVELOPMENT

The U.S. Government may have a paid-up license in this invention and the right in limited circumstances to require the patent owner to license others on reasonable terms as provided for by the terms of U.S. Office of Naval Research (ONR) Grant No. 00014-01-1-0757.

### FIELD OF THE INVENTION

The field of the invention generally relates to three-dimensional (“3D”) battery architectures. More specifically, the field of the invention relates to three-dimensional electrode structures used to improve battery performance and methods of making the same.

### BACKGROUND OF THE INVENTION

Lithium-ion batteries, in which lithium ions shuttle between an insertion cathode (e.g., LiCoO₂) and an insertion anode (e.g., carbon) have emerged as the power source of choice for the high-performance rechargeable-battery market. Lithium-ion batteries use insertion processes for both the positive and negative electrodes. The battery electrodes are usually fabricated in the form of layers and the resulting transport of the lithium (Li) ions between the electrodes, generally arranged in a parallel-plate configuration, is one-dimensional (“1D”) in nature. In order to minimize power losses resulting from slow transport of ions, the thickness of the insertion electrodes, as well as the separation distance between them, is typically kept as small as possible. This approach may appear counterintuitive in the effort to produce a useful battery, because reducing the thickness of the electrode results in lower energy capacity as well as shorter operating times. Thus, in battery design there is always a tradeoff between available energy and the ability to release this energy without internal power losses.

In recent years there has been the realization that improved battery performance can be achieved by reconfiguring the electrode materials currently employed in two-dimensional (“2D”) batteries into 3D architectures. The general strategy of this approach is to design cell structures that maximize power and energy density while maintaining short ion transport distances. While there are many possible architectures that achieve this goal, a defining characteristic of 3D batteries is that transport between electrodes remains one dimensional (or substantially so) at the microscopic level, while the electrodes are configured in complex geometries (i.e., non-planar) in order to increase the energy density of the cell within a given footprint area. In this regard, 3D batteries are able to maximize the ever decreasing amount of available “real estate” in devices and systems. 3D battery architectures are needed to meet both the requirements of short transport lengths and large energy capacity. Improvements in energy per unit area and high-rate discharge capabilities are two of the benefits that may be realized for these 3D devices.

### SUMMARY OF THE INVENTION

In a first aspect of the invention, a 3D electrode structure for use in a battery includes an array of electrode rods forming one of the anode and cathode. An ion-conducting dielectric material (i.e., electrolyte) is disposed on an exterior surface of the array of electrode rods. A second electrode material is disposed within an interstitial space formed between the electrode rods and external to the ion-conducting dielectric material. The electrode material forms the other of the anode and cathode.

In a second aspect of the invention, a 3D battery includes a substrate a plurality of zinc electrode rods projecting from the surface of the substrate. The zinc electrode rods are electrically coupled to a first conductor. A plurality of nickel electrode rods project from the surface of the substrate, the nickel electrode rods being electrically coupled to a second conductor. The plurality of nickel electrode rods are coated with a conformal coating of nickel hydroxide. An electrolyte bathes the plurality of zinc and nickel electrodes. The plurality of nickel and zinc electrode rods may be arranged in an interdigitated manner.

In another aspect of the invention, a three-dimensional electrode structure for use in a battery includes a porous three-dimensional substrate formed from a first electrically conductive material. An ion-conducting dielectric material is disposed on the porous three-dimensional substrate. The ion-conducting dielectric material may be deposited as a thin film or coating on a surface of the porous three-dimensional substrate. A second electrically conductive material is disposed on the ion-conducting dielectric material, wherein the ion-conducting dielectric material separates the first electrically conductive material from the second electrically conductive material.

In yet another aspect of the invention, a method of making a 3D electrode structure includes forming a plurality of electrode rods in a mold. A gap in the mold is formed about the periphery of the electrode rods. The gap is then filled with an ion-conducting dielectric material. The mold is then removed so as to leave an interstitial space between the plurality of electrode rods. The interstitial space is then filled with an electrode material.

In still another aspect of the invention, a method of making a 3D electrode structure includes forming a plurality of apertures in a mold and lining the apertures with an ion-conducting dielectric material. A first electrode material is then deposited in the apertures to form one of the anode or cathode for the battery. The mold is then removed so as to leave the plurality of electrode rods. The interstitial space formed between the electrode rods is then filled with a second electrode material so as to form the other of the anode and cathode.

### BRIEF DESCRIPTION OF THE DRAWINGS

FIG. 1 schematically illustrates the design of a concentric 3D battery. The battery includes a plurality of electrode rods coated with an ion-conducting dielectric material. The electrode rods form one of the battery electrodes (e.g., anode or cathode). The interstitial space is filled with an electrode material and forms the second electrode (the other of the anode or cathode).

FIG. 2 illustrates one embodiment of a battery using the concentric 3D battery architecture of FIG. 1.

FIGS. 3A-3G illustrate a process of forming the concentric 3D battery of FIG. 2 according to one embodiment.

FIGS. 4A-4E illustrate a process of forming the concentric 3D battery of FIG. 2 according to another embodiment.

FIG. 5A illustrates a colloidal filtration process used to fabricate an array of electrodes.

FIG. 5B is a scanning electron microscope (SEM) image of an array of electrode rods prepared by colloidal filtration.

FIG. 6 illustrates a process of forming a nickel-zinc battery according to one aspect of the invention.

FIG. 7A illustrates a SEM image of an interdigitated array of nickel and zinc electrodes in a 3D battery configuration. FIG. 7A further illustrates adjacent columns of nickel and zinc electrode posts (shown by dashed lines).

FIG. 7B illustrates a charge-discharge curve of a 3D nickel-zinc battery for six (6) cycles.

FIG. 8 illustrates a 3D electrode structure for use in a battery having an interdigitated array of plates.

FIG. 9 illustrates a 3D electrode structure for use in a battery having a sponge-like architecture.

### DETAILED DESCRIPTION OF THE PREFERRED EMBODIMENTS

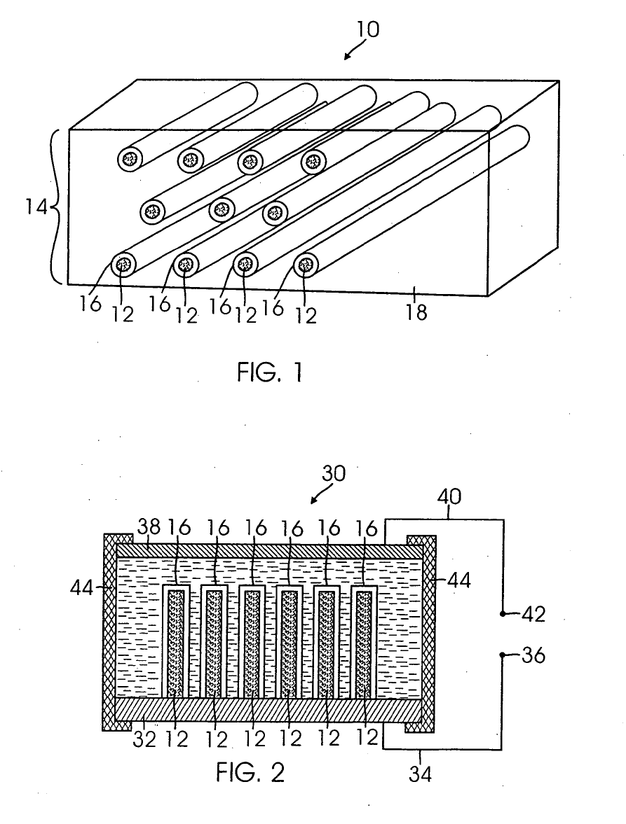

FIG. 1 schematically illustrates a 3D electrode structure 10 according to one embodiment. The 3D electrode structure 10 includes a plurality of electrode rods 12. The plurality of electrode rods 12 may be arranged in an array 14. The array 14 may be ordered or disordered. For example, the array 14 may include a plurality of electrode rods 12 arranged in a periodic arrangement. Alternatively, the array 14 may include a plurality of electrode rods 12 arranged randomly. The electrode rods 12 may form one of the anode or cathode of the 3D electrode structure 10. In one embodiment, the 3D electrode structure 10 is used to form a 3D battery 10 such as that disclosed in FIG. 2. The 3D electrode structure 10 may also be used in non-battery applications. For example, the 3D electrode structure 10 may be used in a sensor.

In one aspect, the electrode rods 12 are formed from, at least in part, a carbon-based material. For example, the electrode rods 12 may be formed mesocarbon microbeads (MCMB). In still another aspect of the invention, the electrode rods 12 may include an electrically conductive (e.g., metallic) inner core that is surrounded or encapsulated by a carbon coating. For example, PCT Patent Application No. PCT/US06/27027 entitled “Method And Apparatus For High Surface Area Carbon Structures With Minimized Resistance” filed on Jul. 11, 2006 discloses such a structure. The above-noted PCT Patent Application is incorporated by reference as if set forth fully herein.

As shown in FIG. 1, the electrode rods 12 are formed having a generally circular cross-sectional shape. It should be understood, however, the electrode rods 12 may have another cross-sectional profiles and still fall within the scope of the present invention. Various cross-sectional shapes for the electrode rods 12 may be formed using different molds (discussed in more detail below). For instance, the electrode rods 12 may be triangular, square, rectangular, oval, polygonal, and the like. Still referring to FIG. 1, the 3D electrode structure 10 includes an ion-conducting dielectric material 16 that is disposed on the exterior surface of the electrode rods 12. The ion-conducting dielectric material 16 may conformally coat the periphery of the electrode rods 12. The ion-conducting material 16 may be formed from a polymer-based material. For example, the ion-conducting dielectric material 16 may be formed from a solid polymethyl methacrylate (PMMA) film around the electrode rods 12. The PMMA film is then “swelled” or expanded by exposing the same to a solution containing an electrolyte such as, for instance, a lithium salt (e.g., lithium perchlorate) dissolved in a solvent such as propylene carbonate. For PMMA, this process needs to be performed in dry atmospheric conditions because the polymer electrolytes are air sensitive.

The film of ion-conducting dielectric material 16 may have a thickness of several microns (e.g., around 10 μm or less). PMMA is one advantageous material because of its fabrication flexibility—all fabrication can be done in air. Of course, other polymer-based ion-conducting dielectric materials 16 besides PMMA may also be used in accordance with the invention.

Still referring to FIG. 1, the 3D electrode structure 10 includes a second electrode material 18 disposed within the interstitial space formed between the electrode rods 12. The electrode material 18 is located external to the ion-conducting dielectric material 16 that conformally coats the electrode rods 12. The second electrode material 18 may be applied by doctor blading electrode material 18 into the interstitial space. Typically, the electrode material 18 has a semi-fluidic or paste-like consistency. In this regard, the electrode material 18 is forced into the interstitial space between the electrode rods 12.

In one embodiment, the electrode rods 12 form the anode while the electrode material 18 forms the cathode of the 3D battery 10. Alternatively, the electrode rods 12 may form the cathode while the electrode material 18 forms the anode of the 3D battery 10. For a lithium ion 3D battery, the electrode rods 12 are the anode while the electrode material 18 forms the cathode. In this embodiment, the electrode rods 12 may be formed from a carbon-based material as described above (e.g., MCMB). The electrode material 18 may include lithium cobalt oxide (LiCoO₂). The ion-conducting dielectric material 16 may include, for example, PMMA that is swelled with a lithium salt-based electrolyte.

The concentric 3D electrode structure 10 of the type disclosed in FIG. 1 is advantageous for several reasons. First, this architecture minimizes the volume occupied by the electrolyte (ion-conducting dielectric material 16). During operation of any battery, the electrolyte is the medium for ion transplant and does not contribute to battery capacity. The total volume of electrolyte in the architecture illustrated in FIG. 1 is substantially less than an interdigitated design where the anode and cathode are separated by a continuous electrolyte phase. Consequently, based on the same aspect ratios, 3D batteries having the architecture of FIG. 1 have higher areal capacity than batteries having an interdigitated design. In addition, the power density of the concentric 3D electrode structure 10 is better because the shorter electrolyte distance will lead to lower ohmic loss.

FIG. 2 illustrates an embodiment of a lithium ion 3D battery 30. The battery 30 is formed from a plurality of electrode rods 12 that are electrically connected to a current collector 32. The current collector 32 may be formed as an electrically conductive plate or substrate. Alternatively, the current collector 32 may be formed as a series of electrical wires or traces that are used to collect current from the electrode rods 12. The current collector 32 may, in turn, be coupled to an electrical conductor 34 that terminates in the anode contact 36 for the battery 30.

The electrode rods 12 are formed, at least in part, from carbon. For example, the electrode rods 12 may be formed from MCMB. In addition, to improve performance the electrode rods 12 may include an interior conductive portion as described in PCT Patent Application No. PCT/US06/27027. The periphery of each electrode rod 12 is conformally coated with an ion-conducting dielectric material 16. In this case, the ion-conducting dielectric material 16 includes PMMA that is swelled with a lithium salt-based electrolyte.

Still referring to FIG. 2, the interstitial space between the electrode rods 12 is filled with an electrode material 18. For the lithium ion battery 30, the electrode material 18 is lithium cobalt oxide. In this architecture, the lithium cobalt oxide acts as the cathode for the battery 30. A second current collector 38 is electrically coupled to the electrode material 18. The second current collector 38 may be formed as an electrically conductive plate or substrate. Alternatively, the second current collector 38 may be an electrically conductive epoxy (e.g. silver or gold epoxy) that is applied over a surface of the electrode material 18. The current collector 38 is coupled to an electrical conductor 40 that terminates in a cathode contact 42 for the battery 30. The battery 30 may also include an optional housing 44 that is used to encapsulate or otherwise secure the various components of the battery 30 into an integrated yet sturdy device.

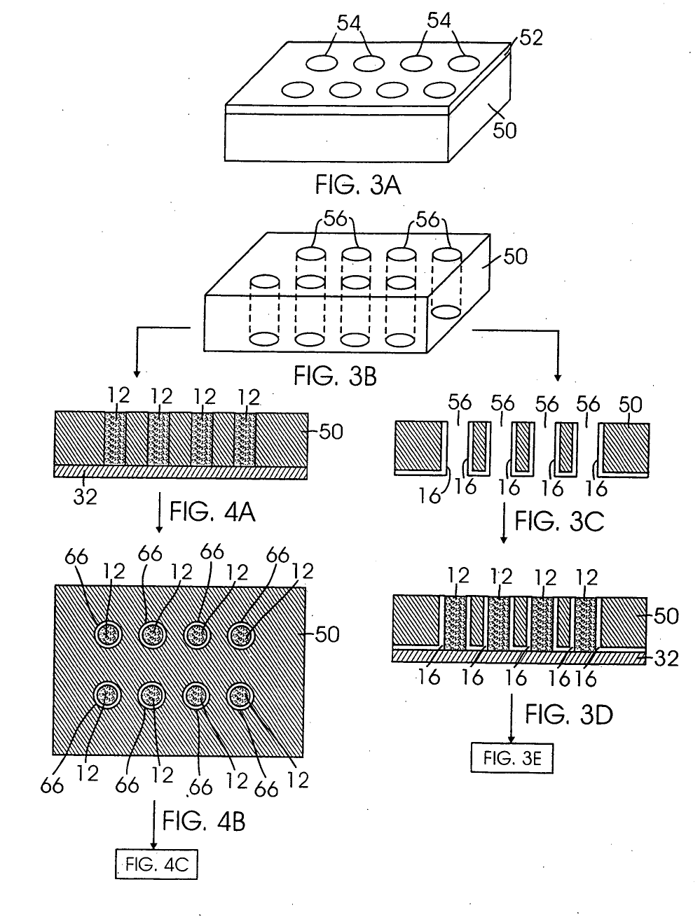

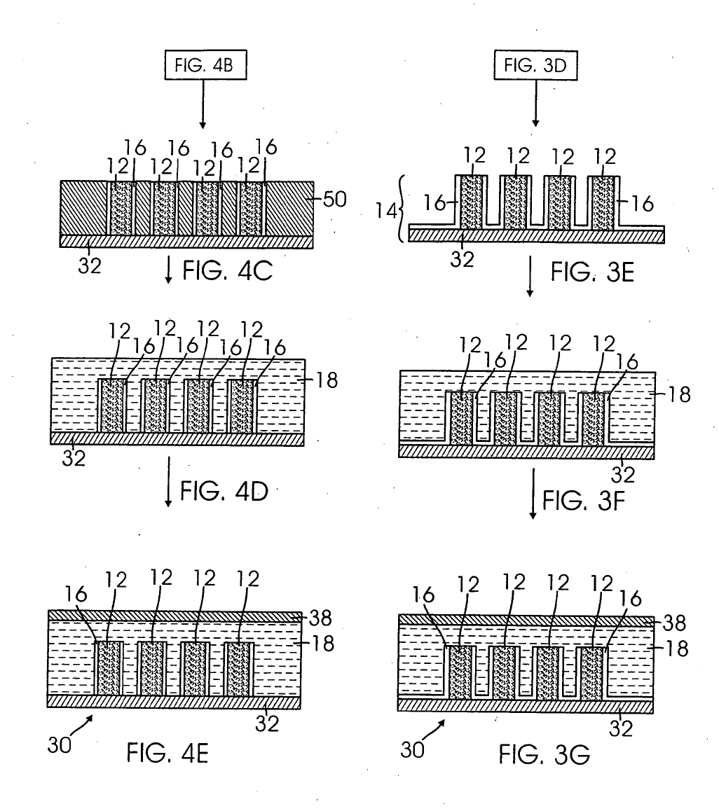

FIGS. 3A-3G and 4A-4E illustrate methods of making the battery 30 of the type illustrated in FIG. 2. Generally, there are two distinct processes that can be employed to form the concentric architecture illustrated in FIGS. 1 and 2. The two methods are used to create the conformal coating of ion-conducting dielectric material 16 around the periphery of the electrode rods 12. The first method, which is illustrated in FIGS. 3A-3G, pre-coats a mold (substrate 50) prior to deposition of the carbon based material forming the electrode rods 12. The second method, which is illustrated in

FIGS. 3A, 3B, and 4A-4E, uses vacuum impregnation of a polymer solution of the ion-conducting dielectric material 16 into a continuous gap 66 created around the mold 50 containing the electrode rods 12.

As seen in FIG. 3A, a substrate 50 is provided with an overlaying layer of photoresist 52. For example, a photoresist layer 52 having a thickness of several microns (e.g., 12 μm) may be spin-coated onto a substrate 50 that is formed from a silicon wafer. The photoresist layer 52 is patterned with a plurality of apertures 54 corresponding to where the electrode rods 12 will be formed. For example, the apertures 54 may be formed as circles having diameters within the range of about 30 μm to about 120 μm. The apertures 54 may be separated by several tens of microns, e.g., around 50 μm. Of course, other geometrical profiles, sizes, and spacings may also be used during this aspect of the process. The UV-exposed portions of the photoresist layer 52 are then dissolved away with developer solution and subject to deep reactive ion etching (DRIE) to form a series of holes 56 in the substrate 50 as shown in FIG. 3B. The holes 56 formed in the substrate 50 may have a depth within the range of about 40 μm to about 120 μm. Of course, the depths of the holes 56 may vary outside this range and still fall within the scope of the present invention. The substrate 50 may then be cleaned in a Piranha bath (H₂SO₄/H₂O₂ solution). Optionally, a layer of thermal oxide may be grown on the silicon substrate 50 using wet oxidation at around 1100° C. The oxide layer may aid in releasing the later-formed electrode array 14.

Referring now to FIG. 3C, which shows a cross-sectional view of the substrate 50, a conformal coating of the ion-conducting dielectric material 16 is applied to the substrate 50 (i.e., mold). The ion-conducting dielectric material 16 may be deposited directly, for example, by pouring a liquid or solution containing the ion-conducting dielectric material 16 over the substrate 50. The viscosity of the liquid or solution is controlled to create a thin yet conformal coating over the interior surfaces of the holes 56. The liquid or solution may have a viscosity value in the range of around 0.1 centipoise and 1000 centipoise. In the case of a lithium ion battery 30, a thin layer (e.g., 5 μm) of solid PMMA coats the interior surfaces of the holes 56. It is also possible that other delivery modalities may be employed to form the conformal coating of ion-conducting dielectric material 16. For example, the coating may be self assembled using copolymers or the like. It may also be possible to grow the coating in site on the substrate 50 directly using, for example, deposition processes.

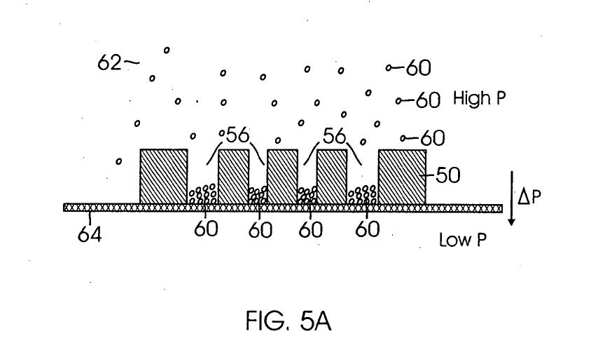

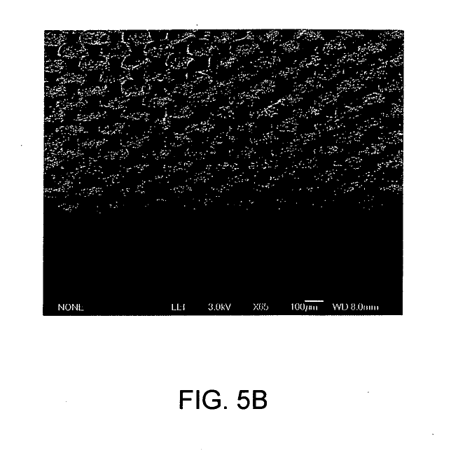

With reference now to FIGS. 3D and 5A, electrode material 60 forming the electrode rods 12 is then deposited within holes 56 formed in the substrate 50. In one aspect of the invention, the electrode material 60 is deposited inside the holes 56 using a colloidal sedimentation process. In this process, which is schematically illustrated in FIG. 5A, the electrode material 60 is suspended in a solution or fluid 62 that is placed over the substrate 50. The substrate 50 is placed on top of a permeable membrane or filter 64. For example, the filter 64 may be formed from a NYLON filter membrane or the like. A pressure gradient (ΔP) is then established across the permeable membrane or filter 64. In this regard, an elevated pressure is formed above the filter 64 while a reduced pressure is present below the filter 64. For example, a pump or the like (not shown) may be used to apply positive pressure above the filter 64. A vacuum pump or the like (not shown) may be used to provide negative pressure on the bottom side of the filter 64. The pressure differential causes the colloidal particles of electrode material 60 to sediment or otherwise accumulate on the filter 64 and within the holes 56 of the substrate 50. This approach advantageously avoids the introduction of air or bubbles being trapped within the substrate 50 and results in a more compact filling of the holes 56.

The colloidal solution generally includes an active electrode powder mixed with a binder. The active electrode powder and binder are then well mixed in a solvent. The active electrode powder may include, for example, LiCoO₂, single-wall carbon nanotubes (SWNT), MCMBs, and VONRs. Typical binders that may be used include, for example, polyvinylidene fluoride (PVDF). When MCMB is used as the electrode material 60, a colloidal solution of 85% (weight) MCMB and 15% (weight) PVDF is mixed in a solution of propylene carbonate (PC). When VONR is used at the electrode material 60, a colloidal solution of 75% (weight) VONR, 15% (weight) carbon black, and 10% (weight) PVDF is mixed in a solution of propylene carbonate (PC). VONR is typically used as the electrical material for the cathode of the battery. Dispersion of the colloidal constituents within the solution may be aided by stirring and/or sonication. FIG. 5A illustrates the accumulation of the electrode material 60 within the holes 56 as a result of this sedimentation process.

Once the holes 56 of the substrate 50 are filled with the electrode material 60, the substrate 50 is dried and heated to melt the binder. For example, if the binder is PVDF, the substrate 50 may be heated to around 200° C. to bind the active electrode powder within the electrode material 60. The heating may take place over several minutes (e.g., 30 minutes) to several hours (e.g., 3 hours).

FIG. 3D illustrates the substrate 50 with the electrode material 60 deposited within the holes 56 using the process described above. FIG. 3D also illustrates a current collector 32 affixed to the underside of the substrate 50. The current collector 32 is in electrical contact with the electrode rods 12. The collector 32 may be a separate plate or the like that is bonded to the electrode rods 12 via an electrically conductive epoxy or adhesive. Alternatively, the current collector 32 may be formed by applying an electrically conductive epoxy directly to the underside of the substrate 50. The epoxy may contain a metallic species (e.g., silver or gold) such that the epoxy can conduct electrical current as well as provide a degree of mechanical integrity to the array 14.

Referring to FIG. 3E, the electrode rods 12 (with conformal coating of dielectric material 16) and collector 32 are separated from the substrate 50. This may be accomplished by immersing the structure of FIG. 3D in an aqueous solution of tetraethylammonium hydroxide (TEAOH) heated to around 80° C. The TEAOH may need to be deoxygenated by bubbling nitrogen gas (or another inert gas) to prevent oxidation of the MCMB. As the TEAOH begins to dissolve the silicon substrate 50, the electrode array 14 separates from the substrate 50. After separation, the released array 14 may be washed with DI water and dried under vacuum at an elevated temperature (e.g., 120° C.).

Next, with reference to FIG. 3F, a second electrode material 18 is then applied to the structure of FIG. 3E so as to fill the interstitial spaces between the electrode rods 12. For example, using the well known doctor blade technique, electrode material 18 in the form of a paste or the like may then forcibly inserted into the interstitial spaces. For example, in the case of a lithium ion battery 30, the paste is formed from a mixture of around 75% (weight) lithium cobalt oxide, 15% (weight) carbon black, and 10% (weight) PVDF in a solvent such as, for instance, propylene carbonate.

FIG. 3G illustrates the structure of FIG. 3F with the addition of a second current collector 38. The structure of FIG. 3F is then dried and heated. Heating may be accomplished at temperatures between around 100° C. to 200° C. for up to one hour. The current collector 38 may be formed by applying an epoxy such as, for example, a gold epoxy to the upper surface of the electrode material 18. Alternatively, a separate conductive plate or the like may be secured to the electrode material 18 using an electrically conductive epoxy or adhesive.

An alternative process of forming the 3D battery 30 is illustrated in FIGS. 3A, 3B, and 4A-4E. The processes described above with respect to FIGS. 3A and 3B are the same in this alternative method. With reference to FIG. 4A, electrode material 60 is deposited within the holes 56 of the substrate 50. The electrode material 60 may be deposited by the same colloidal sedimentation process described above and shown in FIG. 5A. In contrast with the method shown in FIG. 3C, however, there is no “pre-coating” of the substrate 50 prior to initiation of the sedimentation process. FIG. 4A illustrates the deposited electrode material 60 forming the electrode rods 12. FIG. 4A also illustrates a current collector 32 that is electrically connected to the plurality of electrode rods 12. For example, for a lithium ion battery 30, the electrode material 60 may include MCMB or VONR.

Next, as illustrated in FIG. 4B, a continuous gap 66 is etched between the electrode rods 12 and the silicon substrate 50. The continuous gap 66 may be formed by using an aqueous solution of tetraethylammonium hydroxide (TEAOH) heated to around 80° C. for a period of time between about one to four hours. The gap 66 formed about the periphery of the electrode rods 12 is then filled with liquid polymer solution containing the ion-conducting dielectric material 16. For example, the gap 66 may be filled with PMMA. Filling of the respective gaps 66 may be assisted by applying vacuum pressure on the backside of the substrate 50 to draw the liquid polymer into the narrow gap 66. After the liquid has filled the gap 66, the structure is dried and a solid conformal layer of PMMA forms around the periphery of the electrode rods 12 as is shown in FIG. 4C. At this stage, the PMMA is not swelled with the electrolyte as described herein. The solid layer of PMMA will be swelled and loaded with electrolyte in a subsequent step. After swelling the ion-conducting dielectric material 16 may have a thickness on the order of several microns (e.g., 10 μm or less).

After the PMMA layer has coated the electrode rods 12, the silicon substrate 50 is then subject to a dry etch process using, for instance, xenon difluoride to remove the silicon substrate 50. After the silicon substrate 50 has been removed or otherwise separated from the electrode array 14, the PMMA is then swelled or expanded by exposing the same to a solution containing an electrolyte such as, for instance, a lithium salt (e.g., lithium perchlorate) dissolved in propylene carbonate. After loading of the PMMA with the lithium salt, the electrode material 18 is then applied to the interstitial spaces between the electrode rods 12 as is shown in FIG. 4D. The electrode material 18 in the form of a paste or the like may be applied using the doctor blade technique described above. After the electrode material 18 has been applied, a current collector 38 of the type described herein is formed in electrical contact with the electrode material 18.

The process described above in FIGS. 4A-4E may be used to form a lithium ion battery 30. For example, the electrode rods 12 may be formed using MCMB. The ion-conducting dielectric material 16 is formed by loading PMMA with a lithium salt such as, for instance, lithium perchlorate. The second electrode material 18 which forms the cathode of the battery 30 is formed from a paste containing lithium cobalt oxide.

FIG. 5B illustrates a scanning electron microscope (SEM) image of an electrode array 14 prepared using the colloidal sedimentation process described herein. Each electrode rod 12 within the array 14 has an aspect ratio (length divided by diameter) on the order of around 4. Specifically, each electrode rod 12 had a length of around 120 μm and a length of around 500 μm (l/d=4.17).

In another aspect of the invention, an interdigitated nickel-zinc battery 70 was formed. The nickel-zinc battery 70 uses an interdigitated array of zinc electrodes 72 and nickel electrodes 74. The nickel electrodes 74 are formed with a nickel hydroxide conformal layer 76 that forms the cathode of the battery 70. The nickel-zinc battery 70 may be formed with individual electrodes 72, 74 having relative high aspect ratios (e.g., up to about 50:1).

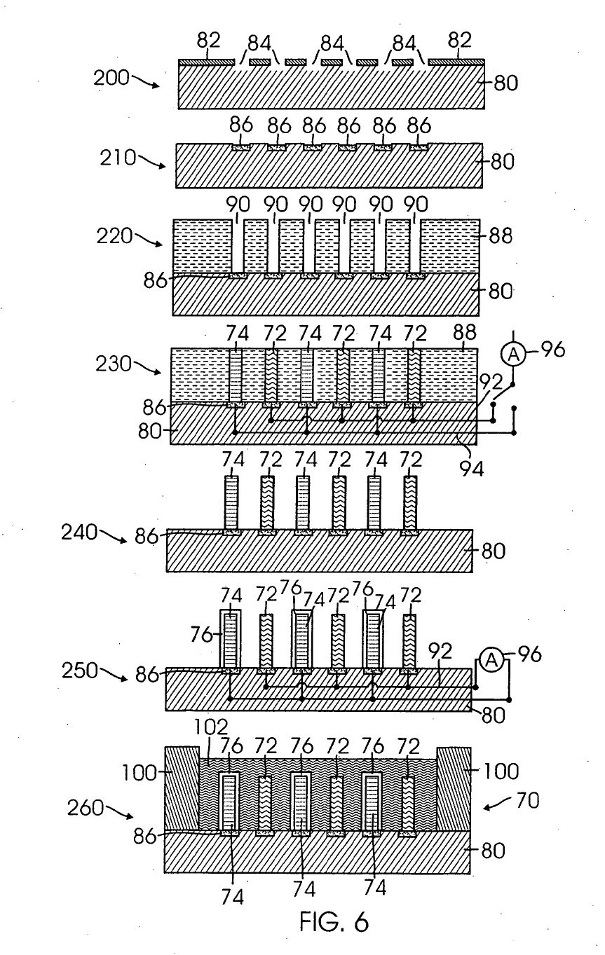

FIG. 6 illustrates a process for forming an interdigitated nickel-zinc battery 70. Initially, in step 200, a substrate 80 such as glass with an overlying layer of photoresist layer 82 is lithographically patterned and subject to a wet etch process to form small apertures or holes 84 in the substrate 80. Next, in step 210, electrode bases 86 are then formed in the holes 84 by deposition of titanium and gold (having a thickness of between about 0.5 to 5 μm) over the photoresist layer 82 and holes 84. The photoresist layer 82 is then removed by, for example, solvent using well known pattern lift-off processes.

In step 220, a silicon mold 88 having preformed holes 90 formed therein is then bonded to the upper surface of the substrate 80. The holes 90 may be formed in the silicon mold 88 by either anodic etching or DRIE. Anodic etching may be used for holes 90 having diameters on the order of several microns (e.g., 10 μm) as well as those holes 90 having high aspect ratios. In contrast, DRIE is used for larger diameter holes 90 (e.g., 50 μm or larger). The silicon mold 88 may be bonded to the upper surface of the substrate 80 by, for example, anodic bonding.

Next, in step 230, the zinc electrodes 72 and nickel electrodes 74 are formed by the successive electroplating of zinc and nickel into the holes 90 in the silicon mold 88. As seen in step 230, the glass substrate 80 is pre-patterned with separate electrical conductors 92, 94. Namely, one conductor 92 addresses the zinc electrodes 72 while another conductor 94 addresses the nickel electrodes 74. This arrangement enables the selective deposition of zinc and nickel by application of current using current source 96.

As seen in step 240, the silicon mold 88 is then removed from the glass substrate 80 and electrodes 72, 74 by etching. For example, this may be accomplished by immersing the structure in an aqueous solution of tetraethylammonium hydroxide (TEAOH) heated to around 80° C. As the TEAOH begins to dissolve the silicon mold 88, the substrate and electrodes 72, 74 separate fully from the silicon mold 88. Next, in step 250, a nickel hydroxide (Ni(OH)₂) layer 98 is electrodeposited over the nickel electrodes 74. The nickel hydroxide is deposited by immersing the electrodes 72, 74 in an aqueous solution of nickel nitrate and applying a current via current source 96. The zinc electrodes 72 act as counter electrodes. In this way, the electric field distribution is uniform around the nickel electrodes 74. Good deposition of Ni(OH)₂ was observed using a 1 M solution of Ni(NO₃)₂ at around 85° C. The deposition process produced a conformal Ni(NO₃)₂ layer 76 having a thickness of around 5 μm. Step 260 illustrates the complete nickel-zinc battery 70. The battery includes a housing 100 that is used to contain an electrolyte solution 102. The electrolyte solution 102 may include, for example, potassium hydroxide (KOH).

The electrochemical behavior of the deposited Ni(NO₃)₂ layer 76 was characterized using a half-cell configuration. In these experiments, only nickel electrodes 74 were deposited in the mold 88 (the holes 90 in the mold 88 for zinc were left open). Nickel hydroxide was deposited over the nickel electrodes 74 as described above. The electrolyte used was 6 M KOH with a sheet of zinc serving as the counter electrode. The discharge behavior that was observed was consistent with that expected for nickel hydroxide, thus indicating that the array of nickel electrodes 74 were working properly. The areal capacity of the array of nickel electrodes 74 was determined to be 0.4 mAh/cm², which is consistent with calculated values.

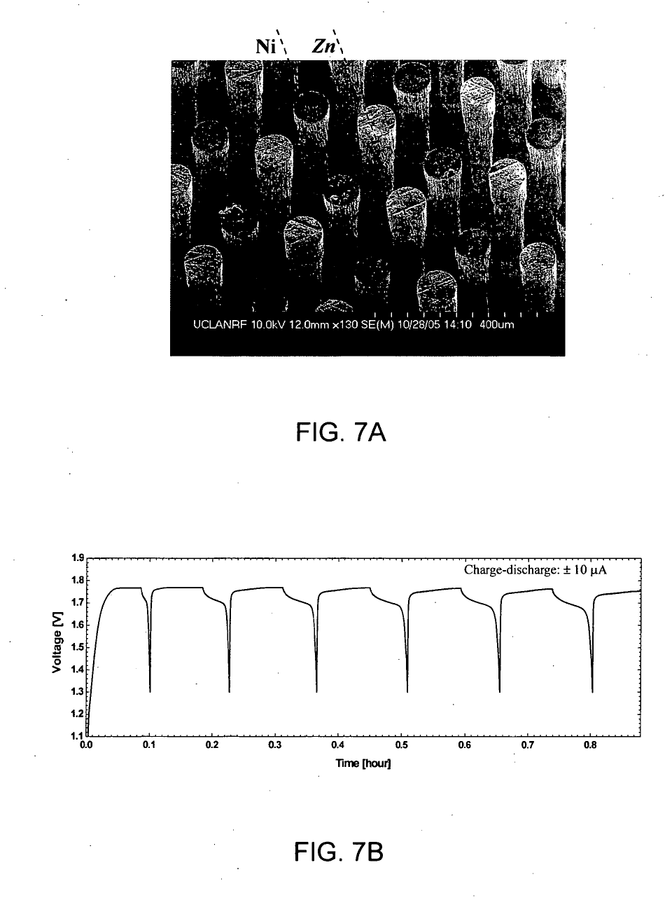

An interdigitated nickel-zinc battery 70 of the type illustrated in FIG. 6 was tested. The nickel-zinc battery 70 included an array of zinc and nickel electrodes 72, 74 having an aspect ratio of around 3:1 on a 0.26 mm² footprint area. FIG. 7A is an SEM image of the nickel-zinc battery 70 prior to deposition of the nickel hydroxide layer 76. FIG. 7B illustrates the charge-discharge characteristics of the nickel-zinc battery 70 over several cycles. For the first few cycles, the discharge capacity increases gradually in each cycle due to the transformation of nickel hydroxide to nickel oxyhydroxide (NiOOH). Because zinc dissolved in the potassium hydroxide electrolyte solution, the cycling of the battery 70 was limited to six (6) cycles.

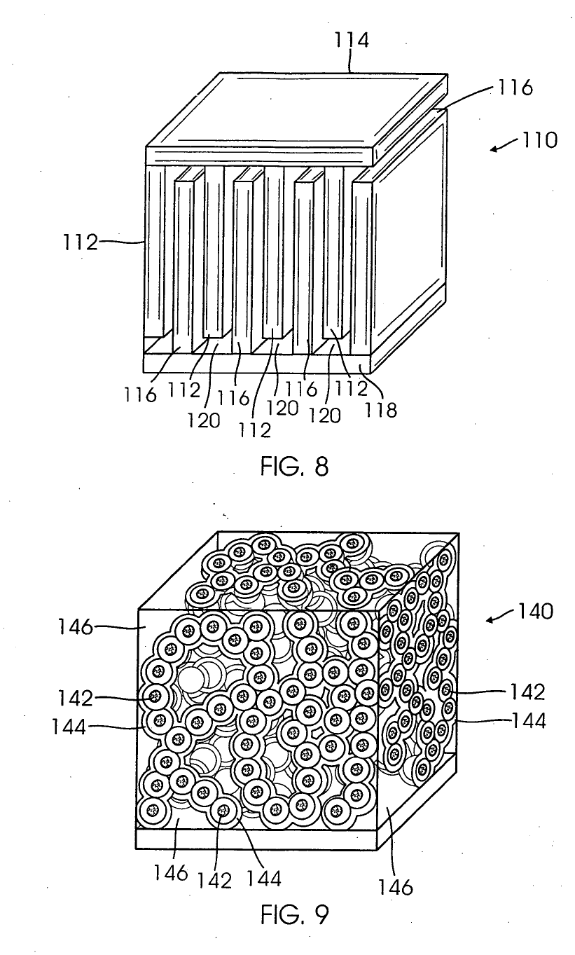

FIG. 8 illustrates yet another embodiment of a 3D battery structure 110. In this embodiment, the battery 110 includes a first plurality of electrically connected plates 112 that form an anode. The plurality of electrically connected plates 112 may be connected at one end to a common current collector 114. A second plurality of electrically connected plates 116 are provided and form the cathode of the battery 110. The second plurality of electrically connected plates 116 may be connected at one end to a second current collector 118 (e.g., opposite current collector 114). The first and second plurality of electrically connected plates 112, 116 are preferably oriented in an interdigitated plate array configuration. Still referring to FIG. 8, an electrolyte 120 is interposed between the first and second plurality of electrically connected plates 112, 116. In one aspect of the invention, the first and second plurality of electrically connected plates 112, 116 may be separated by a distance of less than 100 nm. The architecture of the battery 110 illustrated in FIG. 8 may be formed using, for example, lithographic or MEMS fabrication methods known in the semiconductor processing arts.

For example, if the battery 110 were constructed as a lithium ion battery 110, the first plurality of plates 112 (which form the anode of the battery 110) may be formed from a carbon-based material such as, for example, MCMBs, VONRs, or the like. The second plurality of plates 116 may be formed from lithium cobalt oxide. The electrolyte 120 may be disposed as a continuous phase in between the interdigitated array of plates 112, 116. The electrolyte 120 may be formed from a polymer such as PMMA that is swelled or loaded with ions (e.g., lithium ions).

In yet another embodiment, as illustrated in FIG. 9, a 3D battery 140 includes a porous three-dimensional substrate 142 formed from a first electrically conductive material to form one of the cathode or anode of the battery 140. The porous 3D substrate 142 may comprise a periodic or aperiodic structure. The porous 3D substrate 142 may be formed from, for instance, a macroporous solid, a templated mesoporous solid, or from sol-gel based gels. The porous 3D substrate 142 may be coupled to a current collector (not shown). An ion-conducting dielectric material 144 is disposed on the porous 3D substrate 142. Preferably, the ion-conducting dielectric material 144 is in the form of a thin film and acts as an electrolyte for the battery 140. In one aspect, the ion-conducting dielectric material 144 conformally coats the exterior or exposed surface of the porous 3D substrate 142. For example, the thin film of ion-conducting dielectric material 144 may have a thickness of less than 100 nm. In some instances, the thickness of the thin film may be on the order of 10 nm or less.

Still referring to FIG. 9, the battery 2 includes a second electrically conductive material 146 disposed on the ion-conducting dielectric material 144. The second electrically conductive material 146 fills the interstitial space or free volume of the porous three-dimensional substrate 142 and serves as a continuous phase anode or cathode (depending on whether the porous 3D substrate is the anode or cathode). The architecture of the battery 140 may be formed using conformal deposition methods known to those skilled in the art. In this regard, the ion-conducting dielectric material 144 (e.g., electrolyte) and the electrodes 142, 146 may be sequentially or simultaneously assembled into the battery 140. Film deposition methods may yield electrode and electrolyte films having nanometer-sized thicknesses. In one aspect of the invention, a battery 140 may be formed wherein the two electrode materials 142, 146 are separated by a distance of less than 100 nm and in some instances separated by around 10 nm or less.

In the architecture illustrated in FIG. 9, the porous substrate 142 has an aperiodic or random “sponge” network that may serve as the insertion cathode for a battery 140. The porous substrate 142 is then coated with the ion-conducting dielectric material 144 (e.g., electrolyte) and the remaining free volume is filled with an interpenetrating electrically conductive material 146 that forms the anode of the battery 140. This architecture represents a concentric electrode configuration wherein the ion-conducting dielectric material 144 envelops the porous electrode material 142 while the other electrode material 146 fills the mesoporous and macroporous spaces and surrounds the ion-conducting dielectric material 144. Short transport-path characteristics between the porous 3D substrate 142 (cathode) and the second electrically conductive material 146 (anode) are preserved in this arrangement. In addition, all battery components including the porous 3D substrate 142, ion-conducting material 144, and second electrically conductive material 146 are continuous throughout the sponge-like architecture.

The various 3D battery architectures described herein offer the opportunity to achieve high energy densities in small packages. For example, unlike their 2D counterparts, 3D battery architectures may be able to provide milliwatt-hour energies in cubic millimeter packages or even square millimeter footprints. These 3D battery designs may be able to power small- devices (e.g., MEMS devices) that simply cannot be powered by even the most advanced 2D battery designs. The 3D battery designs described herein enable large areal capacities without a commensurate loss in power density that may result from slow interfacial kinetics (generally associated with small electrode area-to-volume ratios) and ohmic potential losses (typically associated with long transport distances).

While embodiments of the present invention have been shown and described, various modifications may be made without departing from the scope of the present invention. The invention, therefore, should not be limited, except to the following claims, and their equivalents.

What is claimed is:

1. A three-dimensional battery comprising:
a substrate;
a plurality of zinc electrode rods projecting from the surface of the substrate, the zinc electrode rods being coupled to a first conductor;
a plurality of nickel electrode rods projecting from the surface of the substrate, the nickel electrodes being coupled to a second conductor, the plurality of nickel electrode rods being coated with nickel hydroxide; and
an electrolyte bathing the plurality of zinc and nickel electrodes.

2. The battery of claim 1, wherein the plurality of zinc electrodes and the plurality of nickel electrodes are arranged in an interdigitated manner.

3. The battery of claim 1, wherein the plurality of zinc and nickel electrodes and the electrolyte are contained in a housing.

4. A three-dimensional electrode structure for use in a battery comprising:
a porous three-dimensional substrate formed from a first electrically conductive material;
an ion-conducting dielectric material disposed on the porous three-dimensional substrate; and
a second electrically conductive material disposed on the ion-conducting dielectric material, wherein the ion-conducting dielectric material separates the first electrically conductive material from the second electrically conductive material.

5. The three-dimensional electrode structure of claim 4, further comprising first and second current collectors electrically connected to the first and second electrically conductive materials.

6. The three-dimensional electrode structure of claim 4, wherein the porous three-dimensional substrate is aperidoc.

7. The three-dimensional electrode structure of claim 4, wherein the porous three-dimensional substrate comprises an ordered porous network.

8. A method of making a three-dimensional electrode structure comprising:
forming a plurality of electrode rods in a mold;
forming a gap about the periphery of the electrode rods;
filling the gap with an ion-conducting dielectric material;
removing the mold so as to leave an interstitial space between the plurality of electrode rods; and
filling the interstitial space with an electrode material.

9. The method of claim 8, wherein the electrode rods comprise carbon and the electrode material comprises lithium cobalt oxide.

10. A method of making a three-dimensional electrode structure comprising:
forming a plurality of apertures in a mold;
lining the plurality of apertures with an ion-conducting dielectric material;
depositing a first electrode material in the apertures to form one of the anode or cathode; and
removing the mold so as to leave a plurality of electrode rods; and
filling an interstitial space between the electrode rods with a second electrode material so as to form the other of the anode and cathode.

11. The method of claim 10, wherein the first electrode material comprises carbon and the second electrode material comprises lithium cobalt oxide.
